(19) United States
(12) Patent Application Publication
(10) Pub. No.: US 2023/0100460 A1
(43) Pub. Date: Mar. 30, 2023

(54) BATTERY HEAT RADIATION UNIT FOR VEHICLE AND BATTERY CASE FOR VEHICLE INCLUDING THE SAME

(71) Applicants: Hyundai Motor Company, Seoul (KR); Kia Corporation, Seoul (KR)

(72) Inventor: Kyung Mo KIM, Hwaseong-Si (KR)

(73) Assignees: Hyundai Motor Company, Seoul (KR); Kia Corporation, Seoul (KR)

(21) Appl. No.: 17/862,964

(22) Filed: Jul. 12, 2022

(30) Foreign Application Priority Data
Sep. 30, 2021 (KR) 10-2021-0129328

(51) Int. Cl. H01M 10/653; H01M 10/613; H01M 10/625; H01M 50/507

(52) U.S. Cl. CPC H01M 10/653; H01M 10/613; H01M 10/625; H01M 50/507; H01M 2220/20

(57) ABSTRACT

A battery heat radiation unit for a vehicle includes a cell cover configured to cover a side surface on which leads of battery cells overlapping to form a module are formed; and lead cooling portions provided in the cell cover, wherein a first side of each lead cooling portion is thermally connected to each lead of the battery cell, and a second side of each lead cooling portion is connected to a battery heat radiation portion so that each lead of the battery cells is cooled through the battery heat radiation portion.

### CROSS REFERENCE TO RELATED APPLICATION

The present application claims priority to Korean Patent Application No. 10-2021-0129328 filed on Sep. 30, 2021, the entire contents of which is incorporated herein for all purposes by this reference.

### BACKGROUND OF THE PRESENT DISCLOSURE

### Field of the Present Disclosure

The present disclosure relates to a battery heat radiation unit for a vehicle, which is capable of improving heat radiation performance of a battery by being provided with a lead cooling portion, which is a structure for additionally thermally connecting a portion of a lead, which is a maximum heat generation portion of a battery for a vehicle, to the existing battery heat radiation portion and thus is capable of improving durability and stability of the battery and in which the lead cooling portion is integrated with a cover of a case so that assembly is easy and a manufacturing cost is reduced, and a battery case for a vehicle including the same.

### Description of Related Art

Generally, secondary batteries are batteries capable of being repeatedly used because charging and discharging are possible and are formed of battery modules including a plurality of battery cells and battery packs formed by assembling the battery modules so that the secondary batteries may be used power sources for driving motors of electric vehicles (EVs), hybrid electric vehicles (HEVs), and fuel cell vehicles (FCEVs).

The battery pack generates a great deal of heat due to a charging or discharging operation. Generally, a cooling channel of the battery pack is cooled only on an exposed surface of the battery cell by the medium of a heat radiation resin. However, in the case of the battery, because a temperature is not uniformly increased over the entire area and overheating is particularly concentrated on the lead, a separate additional cooling structure is required for electrical connections, such as a lead and a bus bar, through which a large current flows.

On the other hand, in the existing battery module, a cover covering six surfaces of a plurality of overlapping battery cells is formed on each surface, and each cover is integrally combined so that there is a problem in that assembly is complicated and a process is increased, and thus a production cost is increased. Furthermore, in a welding process of integrally coupling each cover, there is a problem in that, due to a welding line facing toward an internal side of the case, an internal battery cell is damaged due to the welding line.

Furthermore, there is a problem in that the existing steel case comes into contact with a battery pack tray made of aluminum, and thus galvanic corrosion also occurs.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery heat radiation unit, which is configured for improving heat radiation performance of a battery by being provided with a lead cooling portion, which is a structure for additionally thermally connecting a portion of a lead, which is a maximum heat generation portion of a battery for a vehicle, to the existing battery heat radiation portion and thus is configured for improving durability and stability of the battery and in which the lead cooling portions are integrated with a cover of a case so that assembly is easy and a manufacturing cost is reduced, and a battery case.

According to one aspect, there is provided a battery heat radiation unit including a cell cover configured to cover a side surface on which leads of battery cells overlapping to form a module are formed; and lead cooling portions provided in the cell cover, wherein a first side of each lead cooling portion is thermally connected to each lead of the battery cells, and a second side of each lead cooling portion is connected to a battery heat radiation portion so that each lead of the battery cells is cooled through the battery heat radiation portion.

The lead cooling portions may extend in a direction in which the leads of the battery cells extend and may be bent at an extending end portion thereof to form a contact in contact with the battery heat radiation portion.

Plastic of a thermally conductive material may be used as the lead cooling portion.

The cell cover may include a first cover provided with a plurality of bus bars connected to each lead of the battery cells, and a second cover configured to cover an external side of the first cover to prevent the leads and the bus bars from being exposed.

A lead slit through which the leads of the battery cells pass to come into contact with the bus bars may be formed in the first cover, and the leads of the battery cells may be thermally connected to the lead cooling portions in a state of coming into contact with the bus bars through the lead slits.

The lead cooling portions may be provided on the internal surface of the second cover facing the first cover, and when the second cover is assembled, the lead cooling portions may be thermally connected to the leads of the battery cells exposed to the outside of the first cover.

The bus bars and the lead cooling portions may be provided to be thermally connected to each other in the first cover, and when the first cover is coupled to the battery cells, the bus bars of the first cover may be connected to the leads of the battery cells, and the lead cooling portions may be thermally connected to the leads of the battery cells through the bus bars.

The lead cooling portions may be connected to a side surface of the bus bars facing the battery cells, and the leads of the battery cells may be connected to a side surface of the bus bars opposite to the battery cells.

A plurality of bus bars corresponding to the leads of the battery cells may be provided in the cell cover, the battery cells overlap to form a plurality of sub-modules, and a bus bar corresponding to an outermost battery cell of the sub-module to electrically connect adjacent sub-modules may be a protruding bus bar in which a protrusion is formed to protrude outwardly from the cell cover and to be exposed thereof.

A connection bus bar may be provided in the cell cover, wherein one end portion of the connection bus bar may be connected to a protrusion of the protruding bus bar on one side and the other end portion thereof may be connected to a protrusion of the protruding bus bar on the other side adjacent to the other end portion.

An accommodation portion in which the protrusion of the protruding bus bar is accommodated may be formed on an external surface of the cell cover, and the protrusion may pass through a bus bar slit formed in the cell cover to be accommodated in the accommodation portion.

The protrusion of the protruding bus bar on a first side and the protrusion of the protruding bus bar on a second side adjacent to the protrusion of the protruding bus bar on the first side may be accommodated in the accommodation portion in which a connection bus bar for connecting the protrusion on the first side to the protrusion on the second side is provided.

According to another aspect, there is provided a battery case for a vehicle, which includes a housing in which an internal space into which the plurality of overlapping battery cells is inserted is provided, a first opening into which the battery cells are inserted is formed on a side surface of the housing, leads of the battery cells are exposed through the first opening, and a second opening is formed on a lower surface thereof so that a lower end portion of the battery cells comes into contact with the battery heat radiation portion through the second opening; a cell cover coupled to an end portion of a side of the first opening of the housing and configured to cover the side surface on which the leads of the battery cells are formed; and lead cooling portions provided in the cell cover, wherein a first side of each lead cooling portion is thermally connected to each lead of the battery cells, and a second side of each lead cooling portion is connected to a battery heat radiation portion so that each lead of the battery cells is cooled through the battery heat radiation portion.

The cell cover may include a first cover which covers the side surface on which the leads of the battery cells are formed, and a second cover which covers the first cover, and the first cover may be formed due to a hinge coupling to the end portion of one side of the first opening of the housing and may cover the side surface on which the leads of the battery cells are formed through pivoting.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an exploded perspective view exemplarily illustrating a battery heat radiation unit and a battery case according to an exemplary embodiment of the present disclosure;

FIG. 2 is a side view exemplarily illustrating the battery heat radiation unit according to an exemplary embodiment of the present disclosure;

FIG. 3 is a projection view exemplarily illustrating a first cover of the battery heat radiation unit according to an exemplary embodiment of the present disclosure;

FIG. 4 is an exploded perspective view exemplarily illustrating a second cover of the battery heat radiation unit according to an exemplary embodiment of the present disclosure;

FIG. 5 is a projection view exemplarily illustrating the second cover of the battery heat radiation unit according to an exemplary embodiment of the present disclosure;

FIG. 6 is a partially enlarged view exemplarily illustrating the second cover of the battery heat radiation unit according to an exemplary embodiment of the present disclosure;

FIG. 7 is a cross-sectional view exemplarily illustrating the battery heat radiation unit according to an exemplary embodiment of the present disclosure;

FIG. 8 is a projection view exemplarily illustrating a first cover of a battery heat radiation unit according to another exemplary embodiment of the present disclosure; and

FIG. 9 is a cross-sectional view exemplarily illustrating the battery heat radiation unit according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Throughout the exemplary embodiment, when a part is referred to as being “connected” to other part, it includes not only a direct connection but also an indirect connection.

Furthermore, when a part is referred to as “including” a component, this refers that the part can include another element, not excluding another element unless specifically stated otherwise.

Hereinafter, configurations and operating principles of various embodiments of the present disclosure will be described in detail with reference to the accompanying drawings.

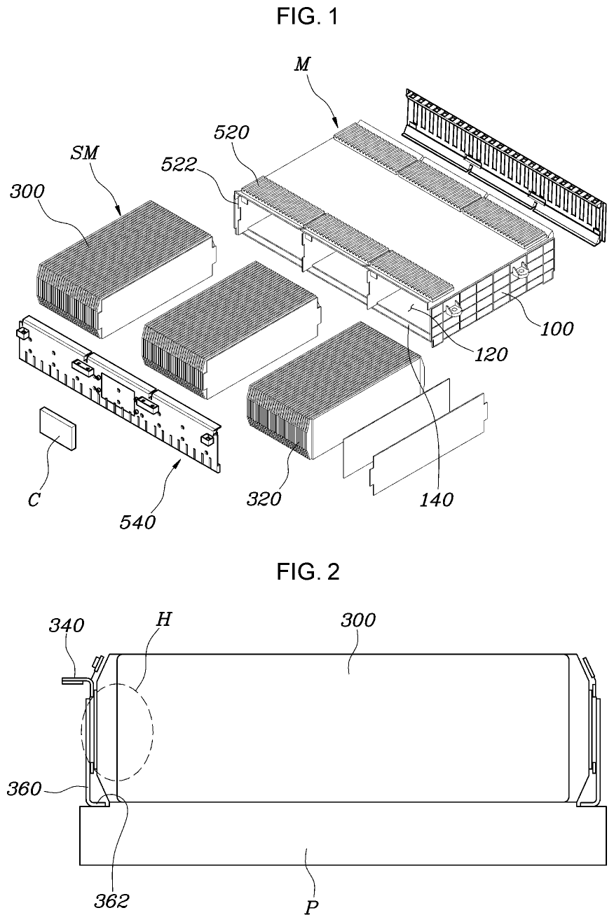

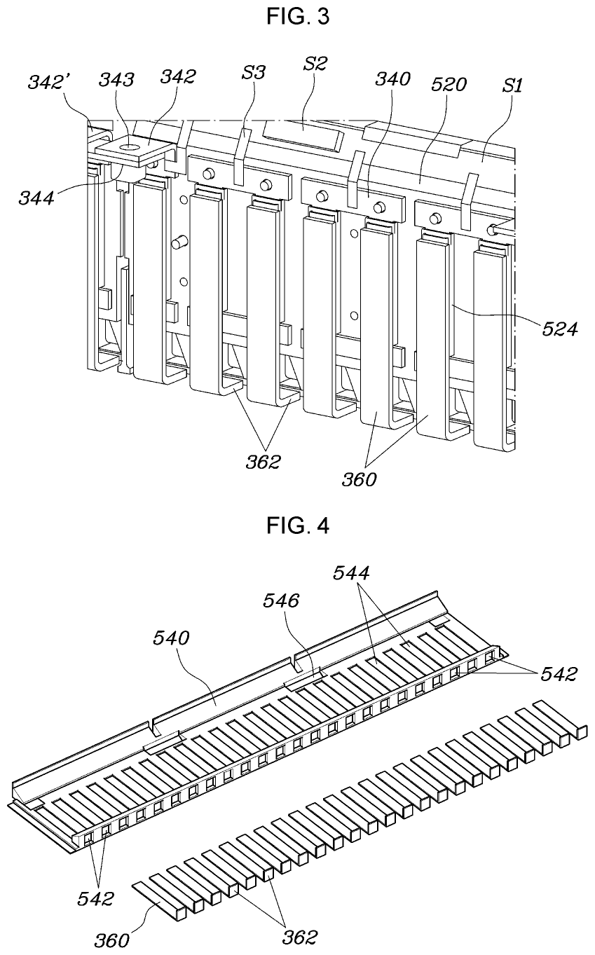

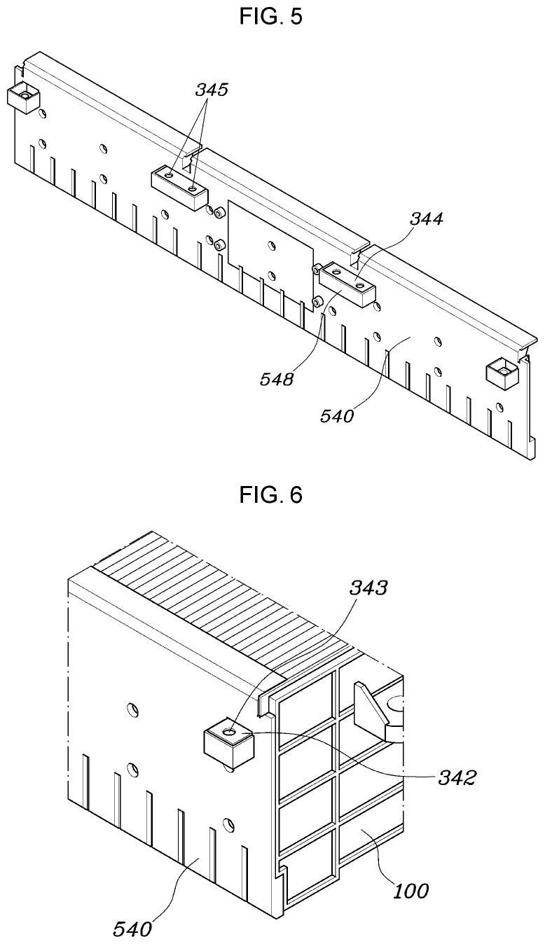

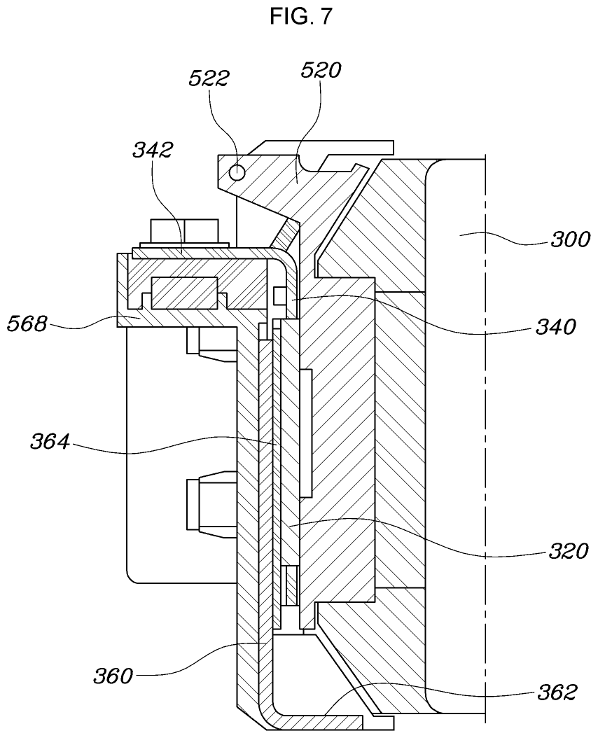

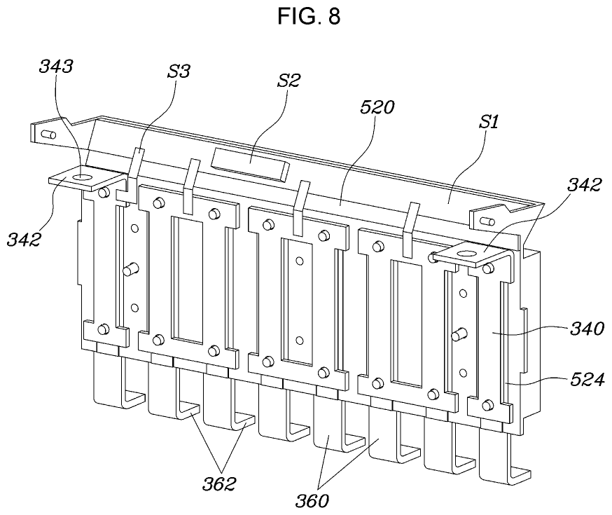

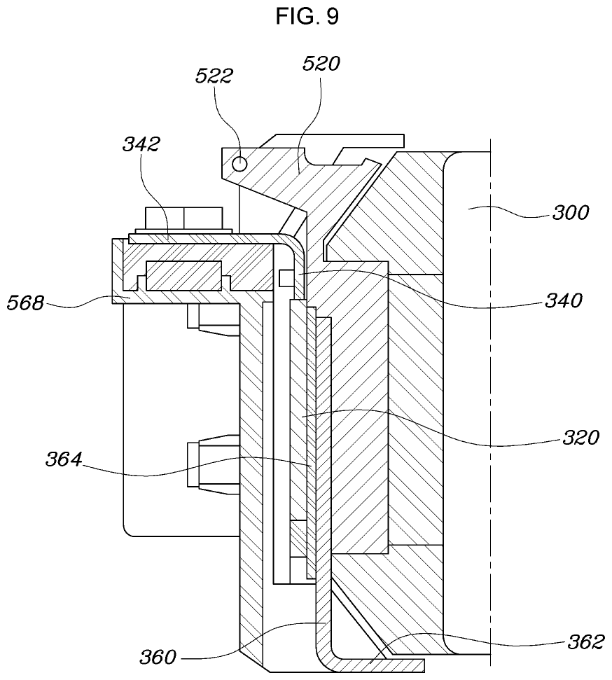

FIG. 1 is an exploded perspective view exemplarily illustrating a battery heat radiation unit and a battery case according to an exemplary embodiment of the present disclosure, FIG. 2 is a side view exemplarily illustrating the battery heat radiation unit according to an exemplary embodiment of the present disclosure, FIG. 3 is a projection view exemplarily illustrating a first cover of the battery heat radiation unit according to an exemplary embodiment of the present disclosure, FIG. 4 is an exploded perspective view exemplarily illustrating a second cover of the battery heat radiation unit according to an exemplary embodiment of the present disclosure, FIG. 5 is a projection view exemplarily illustrating the second cover of the battery heat radiation unit according to an exemplary embodiment of the present disclosure, FIG. 6 is a partially enlarged view exemplarily illustrating the second cover of the battery heat radiation unit according to an exemplary embodiment of the present disclosure, FIG. 7 is a cross-sectional view exemplarily illustrating the battery heat radiation unit according to an exemplary embodiment of the present disclosure, FIG. 8 is a projection view exemplarily illustrating a first cover of a battery heat radiation unit according to another exemplary embodiment of the present disclosure, and FIG. 9 is a cross-sectional view exemplarily illustrating the battery heat radiation unit according to another exemplary embodiment of the present disclosure.

Referring to FIG. 1 and FIG. 2, the battery heat radiation unit according to an exemplary embodiment of the present disclosure includes cell covers 520 and 540 for covering side surfaces on which leads 320 of a plurality of battery cells 300 for a vehicle, which overlap to form a module M, are formed and lead cooling portions 360 provided at the cell covers 520 and 540, each of which one side is thermally connected to the lead 320 of each battery cell 300, and each of which the other side is connected to a battery heat radiation portion P so that the lead 320 of the battery cell 300 is cooled through the battery heat radiation portion P.

Generally, a maximum heat generation portion H of the battery is formed on an external side which is a portion of the lead 320 of the battery cell 300. Accordingly, as shown in FIG. 2, the lead cooling portion 360 including one side provided on an external surface and thermally connected to the lead 320 of the battery cell 300 and the other side connected to the battery heat radiation portion P may be provided. The present lead cooling portion 360 may conduct heat emitted from the maximum heat generation portion H to the battery heat radiation portion P through a lead and a bus bar of the battery to induce cooling of the maximum heat generation portion H, improving performance and durability of the battery. Because the lead and the bus bar of the battery are each formed of a metal material for electrical conduction, heat is also effectively discharged through the metal material so that there is an effect in that there is no need to install a separate heat radiation portion, which is made of a metal material, for heat radiation of a corresponding portion.

Meanwhile, because the cell cover 520 or 540 according to an exemplary embodiment of the present disclosure is integrally provided with a bus bar 340 or the lead cooling portion 360, even without a process of individually assembling the bus bar 340 and the lead cooling portion 360 in a one-to-one manner by corresponding to the lead 320 of each battery cell, with only combination of the cell covers 520 and 540, the bus bar 340 and the lead cooling portion 360 may be thermally connected at once by corresponding to the lead 320 of each battery cell. That is, through a structure of the cover of the present disclosure, because assembly is easy and an unnecessary process is omitted, a manufacturing production cost may be reduced, and contact failures of some of the leads 320 may be prevented in advance.

The lead cooling portion 360 has a shape extending together in a direction, in which the lead 320 of the battery cell 300 extends, and is bent at an extending end portion so that a contact 362 in contact with the battery heat radiation portion P may be formed. That is, the lead cooling portion 360 according to an exemplary embodiment of the present disclosure extends in the direction in which the lead 320 of the battery cell 300 extends and come into surface-contact with the lead 320 so that a contact area with the lead 320 may be maximally increased. Accordingly, because a maximum heat radiation area may be utilized, a cooling effect of the maximum heat generation portion H may be improved.

Furthermore, because the bent portion is formed in the lead cooling portion 360 to come in contact with the battery heat radiation portion P through the contact 362, a structure of the existing battery heat radiation portion P may be utilized. In general, since the battery lead 320 and the battery heat radiation portion P are provided at different location apart from each other and located on different side surfaces, the two elements are thermally connected through the bending of the lead cooling portion 360 so that heat radiation performance may be improved without changing the existing battery design.

Furthermore, for heat radiation of the maximum heat generation portion H, a separate battery heat radiation portion may be additionally provided or a battery heat radiation portion of a new structure may be provided. However, according to an exemplary embodiment of the present disclosure, because only the lead cooling portion 360 is integrally provided on the cover, the above additional components are not necessary so that it is advantageous in terms of a material and a weight.

On the other hand, plastic of a thermally conductive material may be used as the lead cooling portion 360 according to an exemplary embodiment of the present disclosure. Generally, in the battery for a vehicle, the maximum heat generation portion H is located on the lead 320 and the bus bar 340 which have electrical conductivity, and the battery heat radiation portion P is formed in a structure in which an internal flow path is provided and cooling water flows through the flow path so that an insulation characteristic is required, because a large current flows in the lead 320 and the bus bar 340, insulation from the outside thereof is a very important design factor.

Referring to FIG. 2 in detail, heat generated from the maximum heat generation portion H of the battery is conducted to the lead cooling portion 360 which is thermally connected to the lead 320 and the bus bar 340 and is continuously conducted to the contact 362 along an extension of the lead cooling portion 360 so that the heat may be radiated through the battery heat radiation portion P.

That is, the lead cooling portion 360 requires thermal conductivity, and because the other side of the lead cooling portion 360 comes into contact with the battery heat radiation portion P, an insulating characteristic is also required. As a material including these two contradictory characteristics, a heat radiation plastic may be utilized. The heat radiation plastic has thermal conductivity which is lower than thermal conductivity of a conductive metal and has thermal conductivity which is significantly higher than thermal conductivity of general plastic. The heat radiation material applicable to the present disclosure includes LUVOCOM 1301-8312 (28 W/mK), CoolPoly E3603 (20 W/mK), and CoolPoly E5101 (20 W/mK). However, the material of the lead cooling portion 360 is not necessarily limited only to the above examples, and any material including thermal conductivity while electrically insulating will be applicable.

Meanwhile, the cell covers 520 and 540 of the present disclosure may include a first cover 520 provided with a plurality of bus bars 340 connected to the leads 320 of the battery cell 300, and a second cover 540 which covers an external side of the first cover 520 to prevent the leads 320 and the bus bars 340 form being exposed.

Referring to FIG. 3, after the first cover 520 is coupled, because the leads 320 and the bus bars 340 are inevitably exposed to the outside, the second cover 540 which covers and insulates the exposed portions is required. That is, by providing the second cover 540 to cover the exposed portions of the leads 320 and the bus bars 340, leakage or discharging to the outside may be prevented.

Furthermore, because the first cover 520 is integrally provided with the bus bar 340, without performing a process of individually assembling each of the bus bars 340 by corresponding to the lead 320 of each battery cell, the bus bars 340 may be thermally connected to correspond to the lead 320 of each battery cell with only the coupling of the first cover 520. That is, through the structure of the cover of the present disclosure, assembly is easy and contact failures of some of the leads 320 may be prevented in advance.

Furthermore, the first cover 520 may be provided with a sensing portion S2 connected to each bus bar 340 to serve as a sensing block. As components for voltage sensing in the module M of the battery, a sensing line S1 formed along a line of the first cover 520, a sensing portion S2 connected to the sensing line S1, and a flexible printed circuit board (FPCB) S3 for connecting the sensing line S1 may be formed.

Due to application of the FPCB S3, assembly with parts configured for being coupled to the first cover 520 may be easy, and a supplier for providing the parts may provide the cell covers 520 and 540 and parts configured for being coupled to the cell cover 520 after assembled in each part in advance.

Referring to FIG. 1, a wireless communication connector C may be attached to an external side of the second cover 540, and the sensing portion S2 may detect a voltage through the wireless communication connector C. The wireless communication connector C does not necessarily need to be attached to the external side of the second cover 540 and may be attached to various locations according to a shape of the battery of the vehicle.

On the other hand, a lead slit 524 is formed in the first cover 520 of the present disclosure so that the leads 320 of the battery cell 300 pass through to come into contact with the bus bars 340, and the leads 320 of the battery cell 300 may be thermally connected to the lead cooling portion 360 through the lead slit 524 in a state of coming into contact with the bus bars 340.

Referring to FIG. 3, because the lead slit 524 is provided in the first cover 520, even when the first cover 520 is coupled, the leads 320 of the battery cell 300 may be exposed to the outside of the first cover 520 to be connected to the bus bars 340 without adding a separate connection device. As a result, with only the coupling of the first cover 520, the bus bars 340 may be thermally connected to correspond to the leads 320 of the battery cell 300. That is, through the structure of the cover of the present disclosure, assembly may be easy, contact failures of some of the leads 320 may be prevented in advance, and because a separate additional device is not required, a manufacturing production cost may be reduced.

Meanwhile, the lead slit 524 is not necessarily limited only in a form of a slit and may be formed of various types of holes according to a manufacturing method.

Meanwhile, referring to FIG. 7, the lead cooling portion 360 of the present disclosure is provided on an internal surface of the second cover 540 facing the first cover 520, and when the second cover 540 is assembled, the lead cooling portion 360 may be thermally connected to the leads 320 of the battery cell 300 exposed to the outside of the first cover 520.

That is, because the lead cooling portion 360 is integrally provided in the second cover 540, even when a process of individually assembling the lead cooling portion 360 to correspond to each lead 320 of the battery cell 300 is not performed, the lead cooling portion 360 may be thermally connected to correspond to each lead 320 of the battery cell 300 at a time with only the coupling of the second cover 540. That is, through a structure of the cover of the present disclosure, because assembly is easy and an unnecessary process is omitted, a manufacturing production cost may be reduced, and contact failure of some of the leads 320 may be prevented in advance.

Meanwhile, the lead cooling portion 360 is thermally connected to the leads 320 through thermal grease 364, and in a state in which the lead cooling portion 360 is inserted and fitted into the second cover 540, the thermal grease 364 is applied onto an internal surface of the lead cooling portion 360 and then assembly may be performed.

The thermal grease 364 may remove voids on a contact surface between the lead 320, a contact of the bus bar 340, and the lead cooling portion 360, minimizing loss of heat conduction.

On the other hand, in FIG. 3, the lead cooling portion 360 is merely shown to illustrate a state of being thermally connected to the lead 320 and the bus bar 340, and as shown in FIG. 4, the lead cooling portion 360 may be provided in the second cover 540 in an insertion fitting manner.

The lead cooling portion 360 may be inserted through a hole 542 formed in the second cover 540 and be fitted into a groove 544 having a shape corresponding to a shape of the lead cooling portion 360, being assembled.

As described above, because the lead cooling portion 360 is provided on the second cover 540, the second cover 540 may be provided in units of parts as a finished product. Accordingly, because a correct size of the second cover 540 may be secured in units of parts in advance, a size management factor in a module process is reduced so that process efficiency may be improved.

Meanwhile, with reference to FIG. 8, according to another exemplary embodiment of the present disclosure, bus bars 340 and lead cooling portions 360 are provided in a first cover 520 to be thermally connected to each other, and when the first cover 520 is coupled to a battery cell 300, the bus bars 340 of the first cover 520 may be connected to the leads 320 of a cell, and the lead cooling portions 360 may be thermally connected to the leads 320 of the battery cell 300 through the bus bars 340. That is, it may be configured so that the lead cooling portions 360 are inserted into the first cover 520 as internal parts and radiate heat in a state of being in contact with rear surfaces of the bus bars 340.

That is, because the first cover 520 is integrally provided with all the bus bars 340 and the lead cooling portions 360, even without performing a process of individually assembling the bus bars 340 and the lead cooling portions 360 in a one-to-one manner by corresponding to leads 320 of each battery cell, with only combination of a second cover 540, the bus bars 340 and the lead cooling portions 360 may be thermally connected by corresponding to the lead 320 of each battery cell. That is, through a structure of the cover of the present disclosure, because assembly is easy and an unnecessary process is omitted, a manufacturing production cost may be reduced, and contact failure of some of the leads 320 may be prevented in advance.

Furthermore, unlike the above embodiment, when the lead cooling portions 360 are provided in the first cover 520, after the lead cooling portions 360 are inserted into the first cover 520, thermal grease 364 is applied to external surfaces of the lead cooling portions 360 before assembling the bus bars 340, and then assembly may be performed. That is, because the process of applying the thermal grease 364 may be omitted in an operation before assembling the second cover 540 with the first cover 520 in a module assembly line, a size control factor in the module process is reduced so that process efficiency may be improved.

Meanwhile, referring to FIG. 9, the lead cooling portion 360 may be connected to a side surface of the bus bar 340 facing the battery, and the lead 320 of the battery cell 300 may be connected to a side surface of the bus bar 340 opposite to the battery.

In the instant case, because the lead cooling portion 360 is provided in the first cover 520, the lead cooling portion 360 is provided at a position close to the maximum heat generation portion H, and thermal connection (indirect connection) through the battery cell lead 320 and the bus bar 340 and a thermal connection (direct connection) through a contact with the maximum heat generation portion H may be formed. That is, because heat generated in the maximum heat generation portion H is conducted to the battery heat radiation portion P through the direct connection, heat radiation performance may be further improved.

Meanwhile, referring to FIGS. 1 and 3, a plurality of bus bars 340 corresponding to the leads 320 of each battery cell 300 are provided in the first cover 520 of the present disclosure, a plurality of battery cells 300 for a vehicle overlap to form a plurality of sub-modules SM, and to electrically connect adjacent sub-modules SM, the bus bar 340 corresponding to the outermost battery cell 300 of the sub-module SM may be a protruding bus bar 340 in which protrusions 342 and 342′ are formed to be exposed by protruding outwardly from the cell covers 520 and 540.

When the plurality of battery cells 300 are stacked, to secure alignment of the battery cells 300, a maximum number of stackable cells in a single stacking operation is limited. Therefore, in general, the plurality of maximally stacked battery cells 300 are used as the sub-module SM to form one unit of a module M through electrical connection between the sub-modules SM. Thus, according to an exemplary embodiment of the present disclosure, the bus bar 340 corresponding to the outermost battery cell 300 of the sub-module SM is provided with the protruding bus bar 340 in which the protrusions 342 and 342′ are formed to be exposed by protruding outwardly from the cell covers 520 and 540 so that the adjacent sub-modules SM may be electrically connected.

Meanwhile, the protrusions 342 and 342′ may be each manufactured in a form of a quadrangular or circular flat plate, and a fixing portion 343 in a form of a hole is formed in a center portion of the flat plate to be engaged with a fixing bolt. However, the protrusions 342 and 342′ and the fixing portion 343 are not necessarily limited to the above forms and may be manufactured in various forms according to a manufacturing method.

On the other hand, referring to FIG. 5, according to an exemplary embodiment of the present disclosure, a connection bus bar 344 provided in the second cover 540 may be further included, wherein one end portion of the connection bus bar 344 is connected to a protrusion 342 of a protruding bus bar 340 on one side and the other end portion thereof is connected to a protrusion 342′ of a protruding bus bar 340 on the other side adjacent to the other end portion.

Referring to FIGS. 3 and 5, because lower end portions of the protrusions 342 and 342′ of the protruding bus bar 340 are in contact with an upper end portion of the connection bus bar 344, adjacent sub-modules SM may be electrically connected.

Meanwhile, the connection bus bar 344 may be manufactured in a form of a quadrangular or circular flat plate, and two fixing portions 345 in a form of a hole are formed in center portions of both sides in a longitudinal direction of the flat plate so that fixing bolts may be engaged. However, the connection bus bar 344 and the fixing portion 345 are not necessarily limited to the above forms and may be manufactured in various forms according to a manufacturing method.

Meanwhile, referring to FIG. 4 and FIG. 5, an accommodation portion 548 in which the protrusion 342 of the protruding bus bar 340 is accommodated is formed on an external surface of the second cover 540 of the present disclosure, and the protrusion 342 may pass through a bus bar slit 546 formed in the second cover 540 to be accommodated in the accommodation portion 548.

The accommodation portion 548 may cover the protrusion 342 of the protruding bus bar 340 protruding outwardly from the second cover 540, preventing electric leakage or discharging to the outside.

Meanwhile, the accommodation portion 548 may be manufactured in a form of a quadrangular or circular flat plate. However, the accommodation portion 548 is not necessarily limited to the above form and may be manufactured in various forms according to a manufacturing method in accordance with the form of the protruding bus bar 340.

Meanwhile, the bus bar slit 546 is not necessarily limited only in a form of a slit and may be formed of various types of holes according to a manufacturing method.

On the other hand, referring to FIG. 5 and FIG. 6, a connection bus bar 344 may be provided in the accommodation portion 548, wherein the connection bus bar 344 may accommodate both of the protrusion 342 of the protruding bus bar 340 on one side and the protrusion 342′ of the protruding bus bar 340 on the other side adjacent to the protrusion 342 and may connect the protrusion 342 on one side to the protrusion 342′ on the other side thereof.

Because the connection bus bar 344 is provided in the accommodation portion 548, the connection bus bar 344 may be prevented from being exposed to the outside, preventing electric leakage or discharging to the outside.

Meanwhile, the accommodation portion 548 may be manufactured in a form of a quadrangular or circular flat plate. However, the accommodation portion 548 is not necessarily limited to the above form and may be manufactured in various forms according to the form of the connection bus bar 340.

Meanwhile, referring to FIG. 1, a battery case according to an exemplary embodiment of the present disclosure include a housing 100 in which an internal space 120 into which a plurality of overlapping battery cells 300 are inserted is provided, a first opening 140 into which the battery cells 300 are inserted is formed on a side surface of the housing 100, the leads 320 of the battery cells 300 are exposed through the first opening 140, and a second opening is formed on a lower surface thereof so that a lower end portion of the battery cell 300 comes into contact with the battery heat radiation portion P through the second opening; cell covers 520 and 540 coupled to an end portion of the first opening 140 of the housing 100 and configured to cover the side surface where the leads 320 of the battery cells 300 are formed; and lead cooling portions 360 provided in the cell covers 520 and 540, wherein one side of each lead cooling portion 360 is thermally connected to each lead 320 of the battery cell 300, and the other side thereof is connected to the battery heat radiation portion P so that the leads 320 of the battery cells 300 are cooled through the battery heat radiation portion P.

The housing 100 may be formed as an integrated housing through extrusion and brazing methods, and the housing 100 may be provided after being coupled in advance in a state of part modularization from a supplier which supplies the parts. Accordingly, a housing assembly process is omitted, and thus the number of assembly processes is reduced so that an effect of reducing production cost may be achieved.

Furthermore, the battery cells 300 of the present disclosure overlap to form a plurality of sub-modules SM, and each sub-module SM may be inserted through the first opening 140 of the housing 100 to form one battery module M.

Through the housing 100 and an insertion method of the sub-module SM, a separate welding process for forming the housing 100 is omitted so that the battery cell 300 may be prevented from being damaged due to a welding line.

Furthermore, unlike the existing method in which probability of galvanic corrosion with the battery pack tray made of aluminum occurs due to the use of a steel material, the housing 100 of the present disclosure may employ an aluminum material to prevent probability of galvanic corrosion with the battery pack tray.

On the other hand, the cell covers 520 and 540 include the first cover 520 which covers the side surface on which the leads 320 of each battery cell 300 are formed, and the second cover 540 which covers the first cover 520. The first cover 520 may be formed due to a coupling of a hinge 522 to an end portion of one side of the first opening 140 of the housing 100 to cover the side surface on which the leads 320 of the battery cell 300 are formed through pivoting.

Referring to FIGS. 1, 7, and 9, because the cell covers 520 and 540 are coupled and connected to the end portion of one side of the first opening 140 of the housing 100 through the hinge 522, the cell covers 520 and 540 may be stocked as one finished product in units of parts. Accordingly, because correct sizes of the cell covers 520 and 540 may be secured in units of parts in advance, a size management factor in a module process is reduced so that process efficiency may be improved.

Furthermore, the coupling to the housing 100 is easy and thus the assembly process is simplified, and the parts supplier may provide the cell covers 520 and 540 and the housing 100 after coupling each part in advance. Accordingly, the number of assembly processes is reduced so that an effect of reducing production cost may be achieved.

Meanwhile, referring to FIG. 3, the first cover 520 is a component for voltage sensing in the module M of the battery, and the sensing line S1 formed along a line of the first cover 520, the sensing portion S2 connected to the sensing line S1, and the FPCB S3 for connecting the sensing line S1 may be formed.

Even when the first cover 520 is coupled to the end portion of one side of the first opening 140 of the housing 100 and pivoted, the FPCB S3 allows the connection of the sensing line S1 to be maintained. Furthermore, due to the application of the FPCB S3, the part supplier may provide the cell covers 520 and 540 and the housing 100 after coupling each part in advance.

According to the battery heat radiation unit for a vehicle and the case of the present disclosure, the lead cooling portion 360 which is a structure for additionally thermally connecting the lead 320, which is the maximum heat generation portion H of the battery for a vehicle, to the existing battery heat radiation portion P is provided so that it is possible to improve heat radiation performance of the battery, and thus durability and stability of the battery may be improved, and the lead cooling portion 360 is integrated with the covers 520 and 540 of the case so that assembly may be easy and a manufacturing production cost may be reduced.

In accordance with a battery heat radiation unit for a vehicle and a case according to an exemplary embodiment of the present disclosure, a lead cooling portion which is a structure for additionally thermally connecting a lead, which is a maximum heat generation part of a battery for a vehicle, to the existing battery heat radiation part is provided so that it is possible to improve heat radiation performance of the battery, and thus durability and stability of the battery may be improved, and the lead cooling part is integrated with covers of the case so that assembly may be easy and a manufacturing production cost may be reduced.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery heat radiation unit for a vehicle, the battery heat radiation unit comprising:
a cell cover configured to cover a side surface on which leads of battery cells overlapping to form a module are formed; and
lead cooling portions provided in the cell cover, wherein a first side of each lead cooling portion is thermally connected to each lead of the battery cells, and a second side of each lead cooling portion is connected to a battery heat radiation portion so that each lead of the battery cells is cooled through the battery heat radiation portion.

2. The battery heat radiation unit of claim 1, wherein the lead cooling portions extend in a direction in which each lead of the battery cells extends and are bent at an extending end portion thereof to form a contact in contact with the battery heat radiation portion.

3. The battery heat radiation unit of claim 1, wherein the lead cooling portions are made of plastic of a thermally conductive material.

4. The battery heat radiation unit of claim 1, wherein the cell cover includes:
a first cover provided with a plurality of bus bars connected to each lead of the battery cells; and
a second cover configured to cover an external side of the first cover to prevent the leads and the bus bars from being externally exposed.

5. The battery heat radiation unit of claim 4, wherein lead slits through which the leads of the battery cells pass to come into contact with the bus bars are formed in the first cover, and the leads of the battery cells are thermally connected to the lead cooling portions in a state of coming into contact with the bus bars through the lead slits.

6. The battery heat radiation unit of claim 5, wherein the lead cooling portions are provided on an internal surface of the second cover facing the first cover, and when the second cover is assembled, the lead cooling portions are thermally connected to the leads of the battery cells externally exposed of the first cover.

7. The battery heat radiation unit of claim 6, wherein the lead cooling portions are thermally connected to the leads through thermal grease.

8. The battery heat radiation unit of claim 5, wherein the bus bars and the lead cooling portions are provided to be thermally connected to each other in the first cover, and when the first cover is coupled to the battery cells, the bus bars of the first cover is connected to the leads of the battery cells, and the lead cooling portions are thermally connected to the leads of the battery cells through the bus bars.

9. The battery heat radiation unit of claim 8, wherein the lead cooling portions are connected to a side surface of the bus bars facing the battery cells, and each lead of the battery cells is connected to a side surface of the bus bars opposite to the battery cells.

10. The battery heat radiation unit of claim 1, wherein a plurality of bus bars corresponding to the leads of each battery cells is provided in the cell cover, the battery cells overlap to form a plurality of sub-modules, and a bus bar corresponding to an outermost battery cell of the sub-module to electrically connect adjacent sub-modules is a protruding bus bar in which a protrusion is formed to protrude outward the cell cover and to be exposed thereof.

11. The battery heat radiation unit of claim 10, further including:
a connection bus bar provided in the cell cover, wherein a first end portion of the connection bus bar is connected to a protrusion of the protruding bus bar on a first side and a second end portion thereof is connected to a protrusion of the protruding bus bar on a second side adjacent to the second end portion.

12. The battery heat radiation unit of claim 10, wherein an accommodation portion in which the protrusion of the protruding bus bar is accommodated is formed on an external surface of the cell cover, and the protrusion passes through a bus bar slit formed in the cell cover to be accommodated in the accommodation portion.

13. The battery heat radiation unit of claim 12, wherein the cell cover includes:
a first cover provided with the plurality of bus bars connected to each lead of the battery cells; and
a second cover configured to cover an external side of the first cover to prevent the leads and the bus bars from being externally exposed,
wherein the protrusion passes through the bus bars slit formed in the second cover to be accommodated in the accommodation portion.

14. The battery heat radiation unit of claim 12, wherein the accommodation portion covers the protrusion of the protruding bus bar protruding outwardly from the second cover, preventing electric leakage or discharging to the outside.

15. The battery heat radiation unit of claim 12, wherein the protrusion of the protruding bus bar on a first side and the protrusion of the protruding bus bar on a second side adjacent to the protrusion of the protruding bus bar on the first side are accommodated in the accommodation portion in which a connection bus bar for connecting the protrusion on the first side to the protrusion on the second side is provided.

16. A battery case for a vehicle, the battery case comprising:
a housing in which an internal space into which a plurality of overlapping battery cells is inserted is provided, a first opening into which the battery cells are inserted is formed on a side surface of the housing, leads of the battery cells are exposed through the first opening, and a second opening is formed on a lower surface of the housing so that a lower end portion of the battery cells comes into contact with a battery heat radiation portion through the second opening;
a cell cover coupled to an end portion of a side of the first opening of the housing and configured to cover the side surface on which the leads of the battery cells are formed; and
lead cooling portions provided in the cell cover, wherein a first side of each lead cooling portion is thermally connected to each lead of the battery cells, and a second side of each lead cooling portion is connected to a battery heat radiation portion so that each lead of the battery cells is cooled through the battery heat radiation portion.

17. The battery case of claim 16, wherein the cell cover includes:
a first cover which covers the side surface on which the leads of the battery cells are formed; and
a second cover which covers the first cover,
wherein the first cover is formed due to a hinge coupling to an end portion of a side of the first opening of the housing and covers the side surface on which the leads of the battery cells are formed through pivoting.
